(19) United States
(12) Patent Application Publication
(10) Pub. No.: US 2011/0107977 A1
(43) Pub. Date: May 12, 2011

(54) Control feeder for fish tanks

(76) Inventor: Alvin Smalls, Richmond, VA (US)

(21) Appl. No.: 12/924,663

(22) Filed: Oct. 1, 2010

Related U.S. Application Data
(60) Provisional application No. 61/277,994, filed on Oct. 1, 2009.

(51) Int. Cl. A01K 61/00; A01K 63/00; A01K 61/02

(52) U.S. Cl. 119/216; 119/230; 119/248

(57) ABSTRACT

A divider for fish aquariums, comprising a dividing wall that is specially designed for use in fish tanks to keep feeder fish and predatory fish in separate sections during non-feeding times, helping to better control the feeding habits of the latter is provided. Basically square in shape, the Control Feeder for Fish Tanks is offered in various sizes to accommodate virtually any aquarium. The present invention is made from durable, clear plexiglass material, and outlined with rubber sealant to keep the divider securely in place while in use. Outfitted with a series of small openings to facilitate water flow, the Control Feeder for Fish Tanks also contains three (3) larger, circular openings, which can be opened and closed via a sliding door mechanism to allow the feeder fish to pass into the predatory fish section of the aquarium.

### CLAIM OF PRIORITY

This patent application claims priority under 35 USC 119(e)(1) from U.S. Provisional Patent Application Ser. No. 61/277,994 filed Oct. 1, 2009, of common inventorship herewith entitled, “Control Feeder for Fish Tanks.”

### FIELD OF THE INVENTION

The present invention pertains to the field of hobby aquarium accessories and more specifically to hobby aquarium management and access to feeder fish by predatory fish.

### BACKGROUND OF THE INVENTION

The prior art has put forth several designs for separating fish in an aquarium. Among these are:

U.S. Pat. No. 3,499,526 to A. H. Willinger describes a fish feeder assembly comprising a food dispenser for supplying food to fish in an aquarium.

U.S. Pat. No. 5,954,012 to Robert S. Jackson describes a method and device for feeding aquarium fish comprising a device having mesh walls for access of food by the fish.

U.S. Pat. No. 6,443,099 to George James Elwood Boggs describes a separator for a fish display tank which divides the tank into multiple fully viewable regions in fluid communication with each other.

None of these prior art references describe the present invention.

### SUMMARY OF THE INVENTION

It is an object of the present invention to provide an improved device for separating feeder fish from predatory fish in a hobby aquarium.

### BRIEF DESCRIPTION OF THE DRAWINGS

FIG. 1 is a front perspective view of the fish tank divider of the present invention.

FIG. 2 is a front view of an aquarium with the divider of the present invention in place.

FIG. 3 is a top perspective view of an aquarium with the divider of the present invention in place showing no access to the feeder fish by the predatory fish.

FIG. 4 is a top perspective view of an aquarium with the divider of the present invention in place showing access to the feeder fish by the predatory fish.

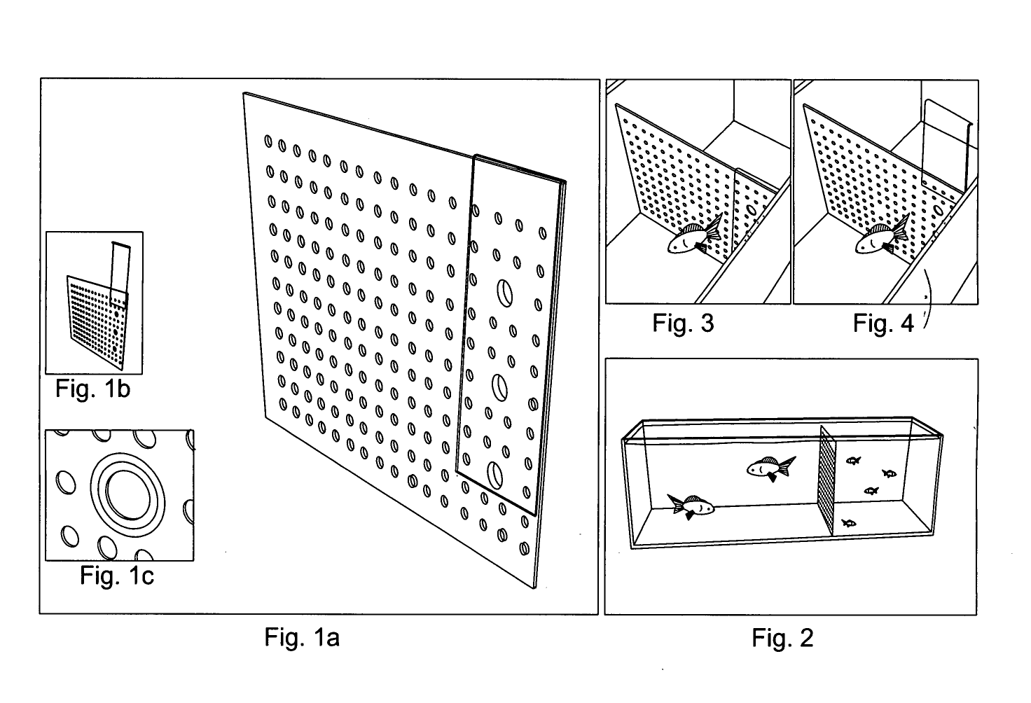

### DETAILED DESCRIPTION OF THE INVENTION

Hobby aquarium fish can even go without food for several days at a time. A simulated underwater paradise that serves as a recreation of deep sea life, the home aquarium offers both fresh and saltwater fish a natural, healthy habitat in which to thrive. In addition, the aquarium provides owners with a fun and relaxing means of watching their pets swimming. Both decorative and functional, aquariums are easily maintained, offer an exciting educational hobby, and are a good vehicle for teaching children responsibility.

Feeder fish are usually some of the easiest fish to keep for the beginning aquarist. The characteristics that make a fish the target of mass breeding include ease of housing, ease of breeding, ease of feeding, tolerance of crowded conditions and tolerance for temperature changes. Many keepers of large, predatory fish choose to feed live fish. Most common feeder fish include small goldfish, guppies or minnows. In some cases, the predator in question will not accept non-living foods, but more often, the aquarist considers live food a special treat, or enjoys watching the natural hunting and eating techniques. However, keeping both feeder and predatory fish in the same aquarium can present challenges. If there are a large number of feeders readily available to the predators, the latter fish may overindulge, which can be unsafe for the pet. Additionally, if too many feeder fish are gobbled up too quickly, the aquarist must spend more money for a fresh supply.

The present invention, hereinafter referred to as the Control Feeder for Fish Tanks, is a practical invention that offers a convenient solution to the aforementioned challenges. Simply stated, the present invention is a dividing wall that is specially designed for use in fish tanks to keep feeder fish and predatory fish in separate sections during non-feeding times, helping to better control the feeding habits of the latter. Basically square in shape, the Control Feeder for Fish Tanks is offered in various sizes to accommodate virtually any aquarium. The present invention is made from durable, clear plexiglas material, and outlined with rubber sealant to keep the divider securely in place while in use. Outfitted with a series of small openings to facilitate water flow, the Control Feeder for Fish Tanks also contains three (3) larger, circular openings, which can be opened and closed via a sliding door mechanism to allow the feeder fish to pass into the predatory fish section of the aquarium. The size of the openings is determined by the user and can be of any of three perforated concentric circles for each large opening. As such, when a Control Feeder for Fish Tanks is placed in the center of an aquarium, the sliding door is closed, covering the large circular openings. Next, the fish are placed in the tank, with the feeders on one side and the predators in the other. When it is feeding time, the owner simply opens the sliding door, granting the feeders access to the predator fish on the other side. When the owner determines the Predator fish have eaten enough, he or she need only re-separate the two types of fish, and re-close the sliding door. With such a simple yet effective product as the Control Feeder for Fish Tanks, aquarium owners can quickly and expediently install the unit, and begin controlling the amount of feeder fish that are consumed in their tanks. As a result, fish owners need not worry that their expensive, exotic predator fish will overeat, which can seriously affect their dietary health. Additionally, much money can be saved over time by not having to constantly replenish the tank with feeders. Manufactured of durable, high quality materials and components such as Plexiglas and rubber, this product will withstand years of continued use. The Control Feeder for Fish Tanks is an innovative invention that readily enhances the aquarium experience for all fish owners. Ideal for home use, this versatile product also proves invaluable to the many offices that display aquariums, not to mention pet stores. Affordably priced, the Control Feeder for Fish Tanks will be well received by a majority of fish aficionados.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A divider for fish aquariums, comprising a basically square dividing wall for use in fish tanks to keep feeder fish and predatory fish separate made from durable, clear Plexiglas™ material, and outlined with rubber sealant to keep the divider securely in place while in use, and further comprising a multiplicity of small openings to permit water flow, and three (3) larger, circular openings, which can be opened and closed by use of a sliding door to allow the feeder fish to pass into the predatory fish section of the aquarium.

2. The divider of claim 1 wherein the three larger circular openings comprise three perforated concentric circles to permit selection of size of opening for each larger opening.

3. A method of controlling the feeding of predatory fish comprising placing a divider in the center of an aquarium to create a first section and a second section, closing the sliding door to cover the large circular openings, placing the fish in the aquarium, with the feeders in the first section and the predators in the second section, opening the sliding door to allow the feeders from the first section to access the second section, allowing the predators to eat the feeders, and closing the sliding door when feeding is complete.
